(19) United States
(12) Patent Application Publication
(10) Pub. No.: US 2025/0045779 A1
(43) Pub. Date: Feb. 6, 2025

(54) Method and system for marketing via a communications network

(71) Applicant: Wei-Sheng Lin, New Taipei City (TW)

(72) Inventor: Wei-Sheng Lin, New Taipei City (TW)

(21) Appl. No.: 18/363,774

(22) Filed: Aug. 2, 2023

(51) Int. Cl. G06Q 30/0201

(52) U.S. Cl. CPC G06Q 30/0201

(57) ABSTRACT

A method and system for helping people marketing by matching people who are willing to recommend each other's project, e.g., advertisement, brand, product, activity, or news. The system generates a marketing URL for each marketing action of users, so that users can obtain the performance report of each marketing action. One of the keys to get users to trust that the system can prevent users from cheating and help users to establish mutually beneficial cooperation is that the system provides a technology that identifies people who click marketing URLs. The system can recognize whether a person clicking on a marketing URL has clicked on the URL before, even if the person's IP address has changed or browser cookies have been cleared, so that the system can prevent users from cheating.

### TECHNICAL FIELD

The present invention relates to a computer method and system for marketing and, more particularly, to a method and system for marketing over the Internet.

### BACKGROUND OF THE INVENTION

Generally speaking, the cost of advertising in the media is expensive. But, each person or entity has a certain degree of marketing power, although the power each individual possesses may seem insignificant. If there is a method and system that can aggregate this power whereby good products can be promoted without high advertising cost.

Furthermore, if good products and ideas are displayed through the system and actively recommended by users of the system, this will form a word-of-mouth.

One form of advertising is known as viral or word-of-mouth. This form usually begins to spread the word through influencers. However, hiring influencers is expensive. In contrast, the present invention matches people who are willing to exchange marketing resources fairly with each other, and generates performance reports whereby the system helps people achieve word-of-mouth and viral marketing without hiring influencers.

### SUMMARY OF THE INVENTION

An embodiment of the present invention provides a method and system for helping people marketing by matching people who are willing to recommend each other's project, e.g., advertisement, brand, product, service, idea, activity, online survey, profile, image, video, channel, article, information, or news. The system provides rules and performance reports to help users cooperate on reciprocity.

Users of the system store the information of their projects on the server, and every time a user recommends a project, the system will automatically generate a new marketing URL to accept clicks by people and generate a report.

One of the keys to get users to trust that the system can prevent users from cheating and help users to establish mutually beneficial cooperation is that the system provides a technology that identifies people who click marketing URLs.

People on the Internet are anonymous. Further, in the Internet, due to privacy concerns, any information gathered should not include any personally identified information. The system can recognize whether people who click marketing URLs are the same person, even if the person's IP address has changed or browser cookie has been cleared. It is a method that is difficult for people to crack even when they want to cheat so that the system can prevent users from cheating and help users to establish mutually beneficial cooperation.

### BRIEF DESCRIPTION OF THE DRAWINGS

FIG. 1 is a block diagram illustrating an embodiment of the present invention.

FIG. 2 illustrates that the system automatically generates a unique marketing URL for each marketing action of users.

FIG. 3 illustrates an exemplary project page with an indeterminate number of buttons.

FIG. 4 is a flow diagram of the system selecting the method with better performance to generate a report of a marketing URL.

FIG. 5 is a flow diagram of the system analyzing data to identify anonymous users.

### DETAILED DESCRIPTION OF THE INVENTION

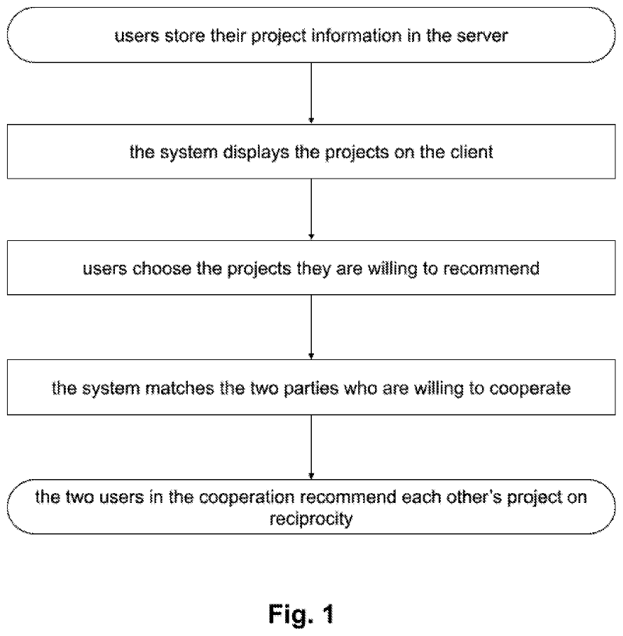

FIG. 1 is a block diagram illustrating an embodiment of the present invention. Users store their project information in the server. The system displays the projects on the client, and users choose the projects they are willing to recommend, and then the system matches the two parties who are willing to cooperate. The two users in the cooperation recommend each other's project on reciprocity.

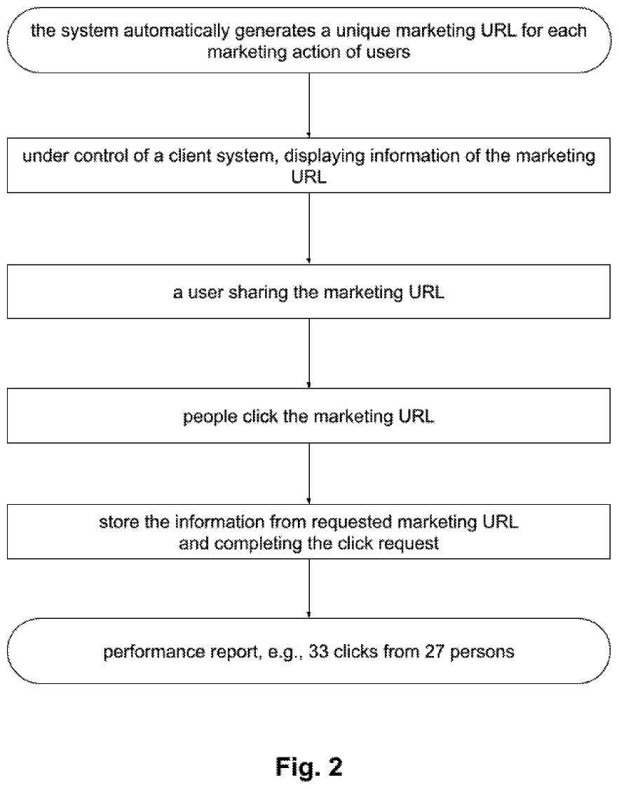

FIG. 2 illustrates that the system automatically generates a unique marketing URL for each marketing action of users, so that users can obtain the performance report (e.g., 33 clicks from 27 persons) of each marketing action.

If people who receive the marketing URLs are interested in knowing about the projects, they will click the marketing URLs for the projects. When people click on the marketing URLs, some information will be derived, including click time, HTTP header fields, interaction details between client and server, etc. The system collects information, and forms big data.

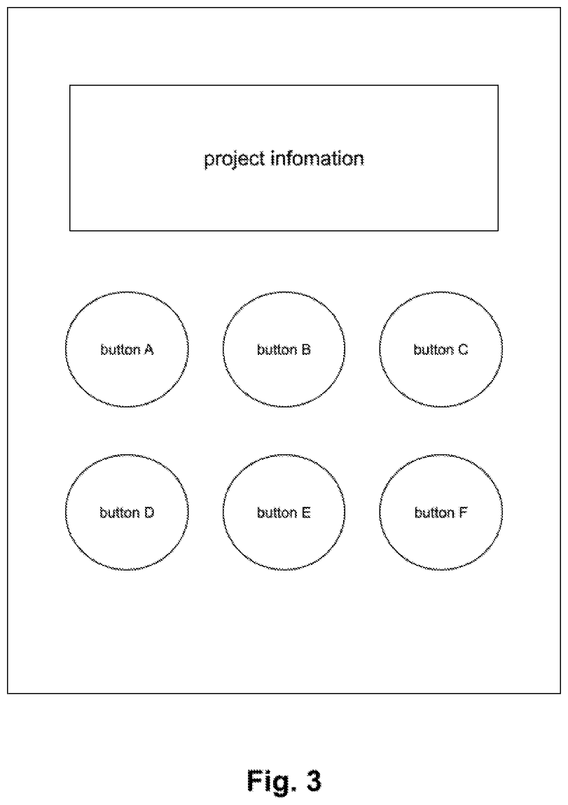

FIG. 3 illustrates an exemplary project page with an indeterminate number of buttons. When the user clicks a button, the marketing URL unique to the click action can be shared/recommended to other people. Each button marks a different channel, e.g., a certain instant messaging software or a certain social media application software. Every time a user clicks a button, what is shared with people is a brand new and unique marketing URL.

In addition to being presented as a button, it can also be in other forms, such as a drop-down menu, drop menu, pull-down list, picklist, radio buttons, option buttons, checkbox.

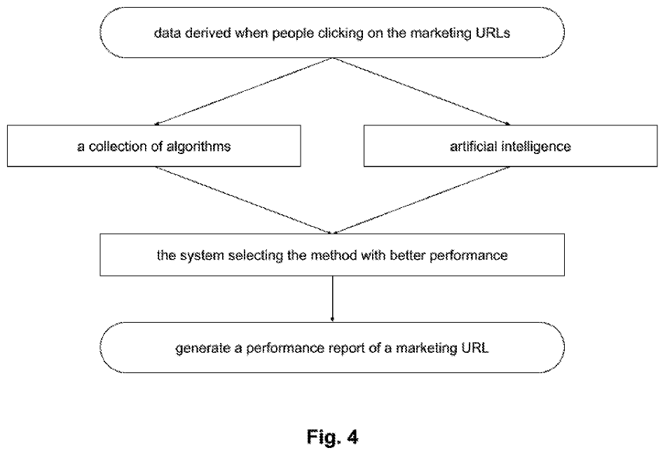

FIG. 4 is a flow diagram of the system selecting the method with better performance to generate a report of a marketing URL.

One method is to use big data to train artificial intelligence through methods such as machine learning or deep learning.

In addition, the present invention invents a method, the concept of which is that when someone clicks on a certain marketing URL, the collection of algorithms calculate the probability that this person is a certain anonymous user. This method is based on research in two directions of scenario analysis and human behavior.

An example of scenario analysis is when a person clicks a marketing URL with a mobile phone, and several days later, the same person clicks another marketing URL using the same mobile phone, the IP address of the person's mobile phone is usually different.

An example of scenario analysis is that everyone has their own life routine, which will form the peak time a person clicks on the marketing URLs.

An example of human behavior is that a single user may want to pretend to be multiple people clicking on the same marketing URL to improve performance of the report.

Scenario analysis is to explore the scenario related to the present invention in daily life. The evolution of science and technology will change people's lifestyle, and the result of scenario analysis will also change accordingly.

The research on human behavior is to explore what users might do if they want to cheat when using the system, and people's cheating methods will change with the evolution of technology.

The collection of algorithms is continuously adjusted based on the above research. The collection of algorithms may be algorithms and/or quantum algorithms.

The collection of algorithms will come up with multiple possible answers after every analysis, for example, the probability that a certain person may be anonymous user A is 80%; and there is a 67% chance that this person could be anonymous user B; and there is a 33% chance that this person could be anonymous user C.

Finally, the system will choose the method with better performance from the two methods of “the collection of algorithms” and “artificial intelligence” to generate a performance report of a marketing URL.

At the moment when the present invention is proposed, some applications based on quantum mechanics are moving from research in the laboratory to commercial use; quantum communication may change network protocol; quantum encryption may change the encryption method of the network; quantum computers and quantum algorithms may affect technological development.

The method and system proposed in the present invention, in terms of big data collection, may be adjusted due to the commercial use of quantum applications; and in terms of artificial intelligence, may be improved due to the commercial use of quantum applications; and in terms of the collection of algorithms, may be adjusted due to the commercial use of quantum applications. The above adjustment of the method and system due to the commercial use of quantum applications is still within the scope of the method proposed by the present invention.

The commercial use of quantum applications may be a kind of software, a kind of hardware, or a combination of software and hardware.

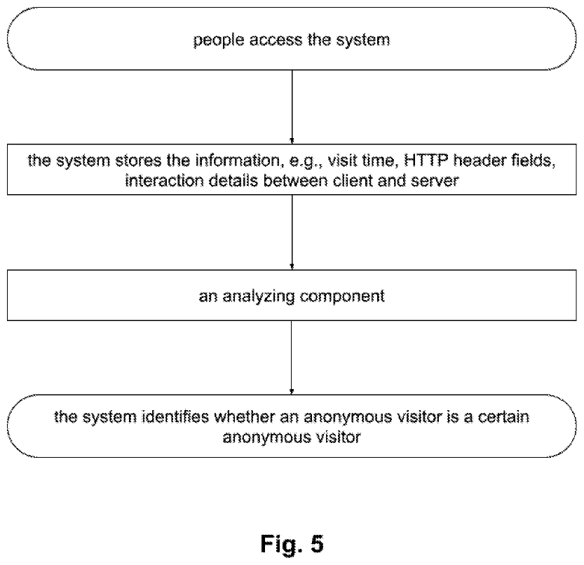

FIG. 5 is a flow diagram of the system analyzing data to identify anonymous users.

When people visit a system, information such as access time, HTTP header fields, interaction details between client and server will be derived, and the system can distinguish each anonymous visitor by analyzing the information through the method proposed by the present invention.

HTTP header fields are a list of strings sent and received by both the client program and server on every HTTP request and response. These headers are usually invisible to the end-user and are only processed or logged by the server and client applications. They define how information sent/received through the connection are encoded (as in Content-Encoding), the session verification and identification of the client (as in browser cookies, IP address, user-agent) or their anonymity thereof (VPN or proxy masking, user-agent spoofing), how the server should handle data (as in Do-Not-Track), the age (the time it has resided in a shared cache) of the document being downloaded, amongst others.

When people visit a system, there will be an interaction between the client and the server. For example, the server requests the client to create some browser cookies, and the client may agree or ignore the request. These interactions are usually invisible to the end-user and are only processed or logged by the server and client applications.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

What is claimed is:

1. A method for marketing, the method comprising:
under control of a client system,
displaying information identifying a project; and
displaying information identifying one or plural marketing URLs; and
in response to only a single action being performed, sharing the marketing URL;
under control of a server system,
generating records to store the information from the marketing URL
whereby the system provides an exclusive marketing URL for each marketing URL sharing action.

2. The method of claim 1 wherein the displaying of information identifying a marketing URL includes displaying information indicating the single action.

3. The client system of claim 1 wherein the predefined action is the clicking of a button.

4. The client system of claim 1 wherein the single action could be clicking a button with the touch of finger, clicking a mouse button when a cursor is positioned over a predefined area of the displayed information, a sound generated by a user, selection using a television remote control, depressing of a key on a keypad, selection using a pointing device, or selection of a displayed indication.

5. The method of claim 1 wherein the single action is clicking a button. To prevent the user from accidentally clicking the button, maybe requiring the user to make a second click and/or agree to a confirm page to confirm the action.

6. The client system of claim 1 wherein a project is associated with one or more marketing URLs.

7. The method of claim 1 wherein the project, the specific content involved in the project, including, but not limited to: advertisement, brand, product, service, idea, activity, online survey, profile, image, video, channel, article, information, or news.

8. The method of claim 1 wherein the way the user shares a marketing URL, including, but not limited to: message, article, QR code, email, video, or voice.

9. A method for marketing, the method comprising:
under control of a client system,
providing an exclusive marketing URL for each marketing URL recommending action; and
a display component for displaying information identifying marketing URLs; and
information including, but not limited to:
the number of clicks on a certain marketing URL; and
how many people clicked on a certain marketing URL; and
the number of times a certain anonymous visitor clicked on a certain marketing URL;
under control of a server system,
a receiving component for receiving requests from people who click the marketing URLs, generating records to store the information, and in response to the URL click action; and
an analyzing component for analyzing records
whereby the system provides users the performance report of each recommending action.

10. The method of claim 9 wherein the way the user recommends a marketing URL could be message, article, QR code, email, video, or voice.

11. The method of claim 9 wherein people who click a marketing URL does not need to explicitly identify themselves when clicking the URL.

12. The method of claim 9 wherein identifies people who click a marketing URL even if a person's IP address changes or browser cookie is cleared by the client, the system can still identify a person whether a person who clicked on the URL before.

13. The method of claim 9 wherein the analyzing component is artificial intelligence.

14. The method of claim 9 wherein the analyzing component is a software and/or hardware.

15. The method of claim 9 wherein the records, including, but not limited to: click time, and HTTP header fields.

16. A method for identifying system visitors, the method comprising:
recording information identifying a person visiting a system; and
an analyzing component for analyzing records
whereby the system identifies visitors.

17. The method of claim 16 wherein a person who visits the system does not need to explicitly identify themselves when visiting the system.

18. The method of claim 16 wherein the information, including, but not limited to: visit time, and HTTP header fields.

19. The method of claim 16 wherein identifies system visitors even if a visitor's IP address changes or browser cookie is cleared by the client, the system can still identify a person whether a person who visited the system before.

20. The method of claim 16 wherein the analyzing component is a software and/or hardware, including: artificial intelligence, algorithm, quantum algorithm, and/or quantum communication equipment.
